(19) United States
(12) Patent Application Publication
(10) Pub. No.: US 2026/0274584 A1
(43) Pub. Date: Sep. 17, 2026

(54) AIRFLOW CURTAIN ASSEMBLIES FOR CONVEYOR SYSTEMS

(71) Applicant: Martin Engineering Company, Neponset, IL (US)

(72) Inventor: Robert Todd Swinderman, Palm Coast, FL (US)

(73) Assignee: Martin Engineering Company, Neponset, IL (US)

(21) Appl. No.: 19/554,164

(22) Filed: Mar. 2, 2026

Related U.S. Application Data
(60) Provisional application No. 63/770,529, filed on Mar. 12, 2025.

(51) Int. Cl. B65G 45/22; B65G 11/02; B65G 11/20

(52) U.S. Cl. CPC B65G 45/22; B65G 11/026; B65G 11/206; B65G 2207/14

(57) ABSTRACT

A conveyor system includes a chute defining a recirculation zone enclosure, and one or more airflow curtain assemblies, each airflow curtain assembly including a frame mounted to the recirculation zone enclosure and a curtain element extending from the frame, a plurality of slits formed in and extending from a lower end of the curtain element opposite the frame to define a plurality of curtain element strips. In embodiments, the airflow curtain assembly includes a fixed frame, a movable frame, and one or more curtain elements provided between the fixed frame and the movable frame and independently attached to the fixed frame and the movable frame.

### CROSS-REFERENCE TO RELATED APPLICATION

This application claims the benefit of co-pending U.S. Provisional Patent Application No. 63/770,529, filed Mar. 12, 2025, for “Airflow Curtain Assemblies For Conveyor Systems,” which is hereby incorporated by reference in its entirety including the drawings.

### TECHNICAL FIELD

The present specification generally relates to conveyor systems including airflow curtains for recirculating the flow of air and, more specifically, airflow curtain assemblies including adjustable, replaceable components.

### BACKGROUND

Conveyor systems are widely used in industrial applications such as mining, manufacturing, and material handling to transport bulk materials efficiently. These systems typically consist of belts, rollers, chutes, and enclosures designed to facilitate continuous movement while minimizing spillage and material loss. A critical challenge associated with conveyor systems is dust generation, which arises from material transfer points, belt loading zones, and discharge areas. To mitigate airborne dust and improve workplace safety and reduce equipment degradation, dust control measures such as enclosures, extraction systems, and airflow curtains are commonly implemented. Airflow curtains, often made from flexible, durable materials, are positioned at conveyor transfer points with the intention of slowing down and allowing fugitive dust to settle and thereby reduce environmental contamination. Despite their widespread use, existing airflow curtain designs frequently suffer from issues such as inadequate sealing, wear and tear, and difficulty in installation and maintenance, do not slow down the air, and are ineffective in reducing dust emissions.

There is a growing need for improved airflow curtains that offer enhanced dust containment, agglomeration, durability, and ease of use. Many conventional designs fail to provide a consistent control of the air due to improper fit, material degradation, or excessive air velocity, which allows excessive dust to escape into the surrounding environment. Additionally, frequent maintenance and replacement of worn out curtains add to operational costs and downtime. Advances in computational fluid dynamics, structural design, and adaptive sealing technologies present opportunities to develop more effective airflow curtains that provide superior containment while maintaining flexibility and ease of installation. An improved airflow curtain system could significantly enhance air quality, reduce maintenance requirements, and improve overall conveyor system efficiency.

In one embodiment, a conveyor system includes: a chute defining a recirculation zone enclosure; and one or more airflow curtain assemblies, each airflow curtain assembly including: a frame mounted to the recirculation zone enclosure; and a curtain element extending from the frame, a plurality of slits formed in and extending from a lower end of the curtain element opposite the frame to define a plurality of curtain element strips.

In another embodiment, an airflow curtain assembly includes: a fixed frame; a movable frame; and one or more curtain elements provided between the fixed frame and the movable frame and independently attached to the fixed frame and the movable frame.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a conveyor system including a plurality of airflow curtain assemblies, according to one or more embodiments shown and described herein;

FIG. 2 schematically depicts a front view of an embodiment of an airflow curtain assembly, according to one or more embodiments shown and described herein;

FIG. 3 schematically depicts a front view of an embodiment of an airflow curtain assembly, according to one or more embodiments shown and described herein;

FIG. 4A schematically depicts a perspective view of an embodiment of an airflow curtain assembly, according to one or more embodiments shown and described herein;

FIG. 4B schematically depicts a front view of the airflow curtain assembly of FIG. 4, according to one or more embodiments shown and described herein;

FIG. 4C schematically depicts an exploded perspective view of a fixed frame and a movable frame of the airflow curtain assembly of FIG. 4A, according to one or more embodiments shown and described herein;

FIG. 4D schematically depicts a partially exploded perspective view of the airflow curtain assembly of FIG. 4A, according to one or more embodiments shown and described herein;

FIG. 5 schematically depicts a perspective view of an embodiment of an airflow curtain assembly, according to one or more embodiments shown and described herein;

FIG. 6 schematically depicts a perspective view of an embodiment of a curtain element, according to one or more embodiments shown and described herein;

FIG. 7 schematically depicts a perspective view of an embodiment of a curtain element, according to one or more embodiments shown and described herein;

FIG. 8A schematically depicts a perspective view of an embodiment of a curtain element, according to one or more embodiments shown and described herein;

FIG. 8B schematically depicts a perspective view of an embodiment of a curtain element, according to one or more embodiments shown and described herein;

FIG. 8C schematically depicts a perspective view of an embodiment of a curtain element, according to one or more embodiments shown and described herein;

FIG. 8D schematically depicts a perspective view of an embodiment of a curtain element, according to one or more embodiments shown and described herein;

FIG. 8E schematically depicts a perspective view of an embodiment of a curtain element, according to one or more embodiments shown and described herein;

FIG. 8F schematically depicts a perspective view of an embodiment of a curtain element, according to one or more embodiments shown and described herein;

FIG. 9 schematically depicts a perspective view of an embodiment of an airflow curtain assembly positioned within a chute, according to one or more embodiments shown and described herein;

FIG. 10 schematically depicts a perspective view of an embodiment of an airflow curtain assembly, according to one or more embodiments shown and described herein;

FIG. 11A schematically depicts a perspective view of an embodiment of an airflow curtain assembly positioned within a chute, according to one or more embodiments shown and described herein;

FIG. 11B schematically depicts a perspective view of a fixed frame of the airflow curtain assembly of FIG. 11A, according to one or more embodiments shown and described herein;

FIG. 11C schematically depicts a perspective view of a movable frame of the airflow curtain assembly of FIG. 11A, according to one or more embodiments shown and described herein;

FIG. 11D schematically depicts a cross-sectional view of the airflow curtain assembly of FIG. 11A taken along line 11E-11E of FIG. 11A in an unassembled state, according to one or more embodiments shown and described herein;

FIG. 11E schematically depicts a cross-sectional view of the airflow curtain assembly of FIG. 11A taken along line 11E-11E of FIG. 11A in an assembled state, according to one or more embodiments shown and described herein;

FIG. 12A schematically depicts a perspective view of an embodiment of an airflow curtain assembly positioned within a chute, according to one or more embodiments shown and described herein;

FIG. 12B schematically depicts an exploded perspective view of the airflow curtain assembly and the chute of FIG. 18, according to one or more embodiments shown and described herein;

FIG. 13 schematically depicts a perspective view of an embodiment of an airflow curtain assembly positioned within a chute, according to one or more embodiments shown and described herein;

FIG. 14A schematically depicts a perspective view of an embodiment of an airflow curtain assembly in a first position within a chute, according to one or more embodiments shown and described herein;

FIG. 14B schematically depicts a perspective view of the airflow curtain assembly of FIG. 14A in a second position within the chute, according to one or more embodiments shown and described herein;

FIG. 15A schematically depicts a perspective view of an embodiment of an airflow curtain assembly in a first position within a chute, according to one or more embodiments shown and described herein;

FIG. 15B schematically depicts a perspective view of the airflow curtain assembly of FIG. 15A in a second position within the chute, according to one or more embodiments shown and described herein; and

FIG. 15C schematically depicts a perspective view of the airflow curtain assembly of FIG. 15A in a third position outside the chute, according to one or more embodiments shown and described herein.

### DETAILED DESCRIPTION

Embodiments described herein are directed to conveyor systems including one or more airflow curtains to control a flow of air and dust through the conveyor system.

The airflow curtain assembly includes a fixed frame, a movable frame, and a plurality of curtain elements provided between the fixed frame and the movable frame and independently attached to the fixed frame and the movable frame. Various embodiments of the airflow curtain assemblies and the operation of the airflow curtain assemblies are described in more detail herein. Whenever possible, the same reference numerals will be used throughout the drawings to refer to the same or like parts.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Directional terms as used herein - for example up, down, right, left, front, back, top, bottom - are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

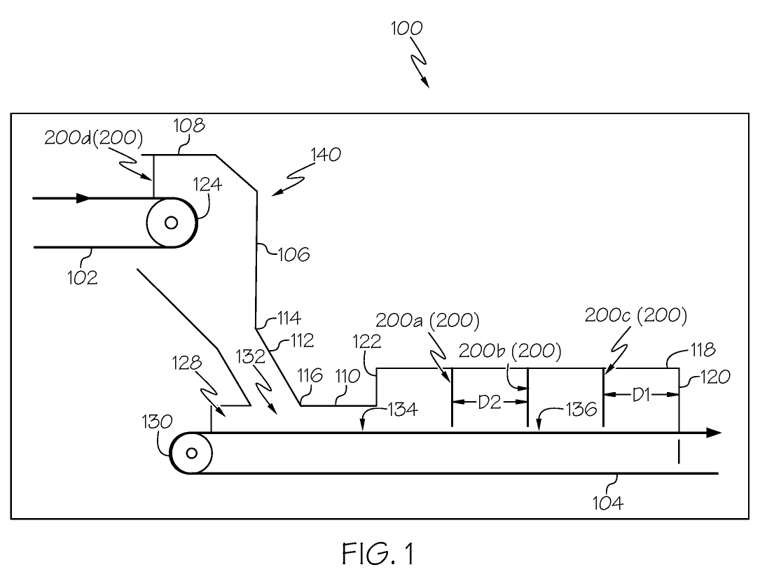

Referring now to FIG. 1, a conveyor system 100 is illustrated according to one or more embodiments described herein. The conveyor system 100 may generally include a discharge conveyor 102 and a receiving conveyor 104 at least partially enclosed by a chute 106. The chute 106 includes a head chute portion 108, a receiving chute portion 110, and a transition chute portion 112 extending between the head chute portion 108 at a proximal end 114 and the receiving chute portion 110 at a distal end 116. The receiving chute portion 110 defines a recirculation zone enclosure 118 having a front end 120 and a rear end 122 opposite the front end 120.

As shown, a leading end 124 of the discharge conveyor 102 extends into the head chute portion 108, and the receiving chute portion 110 encloses an upper portion of the receiving conveyor 104. The receiving conveyor 104 defines a plurality of zones such as, for example, a tail box 128 located proximate a rear roller 130 and downstream of the distal end 116 of the transition chute portion 112, a load zone 132 located downstream of the tail box 128 and at the distal end 116 of the transition chute portion 112, a settling zone 134 located downstream of the load zone 132, and a recirculation zone 136 located downstream of the settling zone 134. The recirculation zone 136 is located at the recirculation zone enclosure 118 of the receiving chute portion 110. The tail box 128 is a rearward extension of the receiving chute portion 110 designed to help seal a rear end of the receiving chute portion 110 from loading turbulence and, on inclined conveyors, roll back of cargo. The load zone 132 is where the discharged cargo impacts the receiving conveyor 104, and the settling zone 134 is where the cargo calms down from impact into a stable cross-sectional profile. The recirculation zone 136 is an enlarged and lengthened enclosure where the air velocity is slowed down by an increased cross-sectional area and airflow curtain assemblies are used to create recirculation.

In embodiments, one or more airflow curtain assemblies 200 are provided within the head portion 108 and the recirculation zone enclosure 118. As shown, three airflow curtain assemblies 200 are mounted to the receiving chute portion 110 partially within the recirculation zone enclosure 118. However, it should be appreciated that one or more airflow curtain assemblies 200 may be provided within the recirculation zone enclosure 118 such as, for example, two or more than three. The airflow curtain assemblies 200 are provided to create recirculation of the flow of air within the receiving chute portion 110 and cause the dust to settle by creating a longer residence time and through agglomeration.

In operation, an air velocity within the recirculation zone enclosure 118 is determined by an input volume divided by a cross sectional area of the recirculation zone enclosure 118. The airflow curtain assemblies 200 create a pressure differential across the airflow curtain assemblies 200 curtain which in turn creates vortices between the rear end 122 and the airflow curtain assembly 200a and subsequent recirculation cells created by airflow curtain assemblies 200a, 200b, 200c. The air in the recirculation zone enclosure 118 is forced into cycles of speeding up and slowing down. The overall average air speed and flow volume is reduced only by entry friction losses between the curtains, the recirculation zone enclosure 118, and the clearance over the bulk material. When the geometry of the airflow curtain assembly 200 is such that the pressure-drop across an airflow curtain assembly 200 of approximately 50%, a robust recirculation of air is created between airflow curtain assemblies 200.

The airflow curtain assemblies 200 include a first airflow curtain assembly 200a proximate the rear end 122 of the recirculation zone enclosure 118, a second airflow curtain assembly 200b, and a third airflow curtain assembly 200c proximate the front end 120 of the recirculation zone enclosure 118. Accordingly, the second airflow curtain assembly 200b is positioned between the first airflow curtain assembly 200a and the third airflow curtain assembly 200c. A distance D1 between the third airflow curtain assembly 200c and the front end 120 of the recirculation zone enclosure 118 is equal to or greater than 1 hydraulic diameter (H_{d}). 1 H_{d} for a rectangular duct is equal to (2 x width x height) / (width + height), where the width and height are that of the recirculation zone enclosure 118. In embodiments, a distance D2 between adjacent airflow curtain assemblies 200 is equal to or greater than 1 H_{d}. In embodiments, the airflow curtain assemblies 200 are equidistantly spaced apart from one another. In embodiments, the airflow curtain assemblies 200 are spaced at multiple and/or alternating intervals from one another. In embodiments, the recirculation zone enclosure 118 has a cross-sectional area sized where the induced, displaced, and generated air volume is managed, such that an average air flow is about 3 m/s. In other embodiments, the recirculation zone enclosure 118 has a cross-sectional area sized such that an average air flow is less than or equal to 3 m/s. The recirculation zone enclosure 118 may have a greater average velocity, which may result in increased emissions.

A volume of the flow of air is in m³/s. The volume of induced air that flows through the chute 106 may be calculated based on the open area, tonnage, particle size and drop distance. The induced air varies directly with the open area of the chute portion. It is well known in the art that additional sources of generated and displaced air can be calculated and will contribute to the overall volume of air flow. Alternatively, the total air flow volume can be measured on existing installations at the front end 120 of the recirculation zone enclosure 118. In embodiments, for negative pressure dust extraction, only a single airflow curtain assembly 200 is provided near an exit of the recirculation zone enclosure 118 to reduce air flow into the recirculation zone enclosure 118, thereby limiting the volume of air the extraction equipment has to treat. This feature, intended for active dust extraction, has become a de facto standard used for passive dust control. A single exit curtain reduces the exit area and increases the exit velocity. This practice, when used for passive dust control, keeps dust entrained in the air flow, does not create significant recirculation, and results in excessive dust emissions.

In embodiments, a transfer point 140 extends between the head chute portion 108 and the receiving chute portion 110. In embodiments, as shown in FIG. 1, a head airflow curtain assembly 200d is provided within the transfer point 140 between the discharge conveyor 102 and the receiving conveyor 104. The head airflow curtain assembly 200d at the head portion 108 reduces an open area within the conveyor system 100. This is where the induced air is created by the discharged particles separating as they fall, creating a vacuum between the particles, inducing or “pulling air” into the transfer anywhere between the head portion 108 and the load zoner 132. The curtain element 200d reduces the open area in conveyor system 100, thus restricting air being pushed into the recirculation zone enclosure 118 by the continuous generation of induced air.

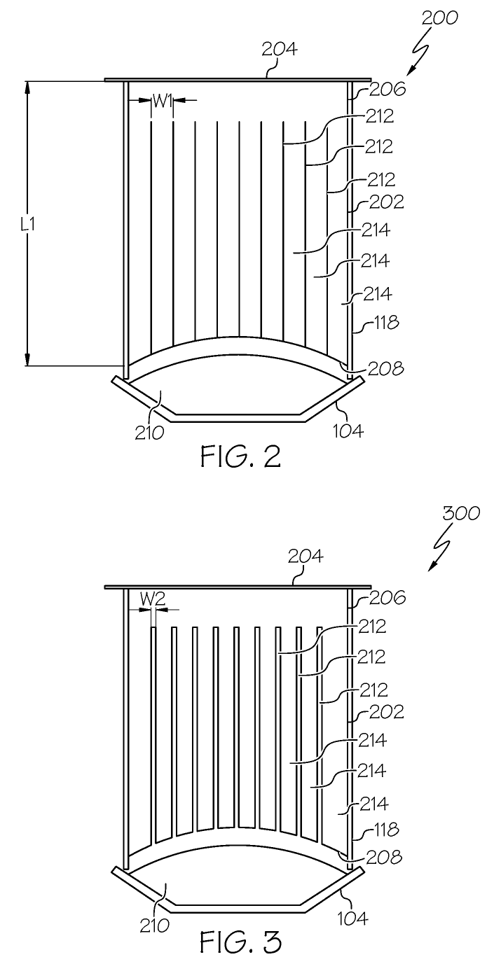

Referring now to FIG. 2, one of the airflow curtain assemblies 200 is depicted. The airflow curtain assembly 200 includes a curtain element 202 mounted to a mounting portion 204. The curtain element 202 includes an upper end 206 and a lower end 208 opposite the upper end 206. The curtain element 202 has a thickness equal to or greater than 6 millimeters (mm) and less than or equal to 18 mm. In embodiments, the thickness of the curtain element 202 is equal to or greater than 10 mm and less than or equal to 14 mm. In embodiments, the thickness of the curtain element 202 is equal to or greater than 11 mm and less than or equal to 13 mm. In embodiments, the thickness of the curtain element 202 is equal to or greater than 14 mm and less than or equal to 25 mm. As shown, the curtain element 202 has a length L1 such that the lower end 208 of the curtain element 202 terminates above cargo 210 traveling along the receiving conveyor 104. In embodiments, the lower end 208 of the curtain element 202 terminates 25 mm +/- 5 mm above the cargo 210. In embodiments, the lower end 208 of the curtain element 202 terminates 25 mm +/- 10 mm above the cargo 210. In embodiments, the lower end 208 of the curtain element 202 terminates 25 mm +/- 15 mm above the cargo 210. In embodiments, the lower end 208 of the curtain element 202 terminates 25 mm +/- 20 mm above the cargo 210. In embodiments, the lower end 208 of the curtain element 202 terminates 50 mm +/- 5 mm above the cargo 210. In embodiments, the lower end 208 of the curtain element 202 terminates 50 mm +/- 10 mm above the cargo 210. In embodiments, the lower end 208 of the curtain element 202 terminates 50 mm +/- 15 mm above the cargo 210. In embodiments, the lower end 208 of the curtain element 202 terminates 50 mm +/- 20 mm above the cargo 210. In embodiments, the lower end 208 of the curtain element 202 terminates 50 mm +/- 25 mm above the cargo 210. In embodiments, the lower end 208 of the curtain element 202 is curved to accommodate the shape of the cargo 210 accumulating on the receiving conveyor 104 generally described by and arc tangent to the surcharge angle of the bulk material per Conveyor Equipment Manufacturers Association (CEMA) standards. The curtain element 202 may be formed from any suitable material such as, for example, rubber, cast polyurethane, high performance urethane, or the like, and may be molded or water jet cut.

As shown in FIG. 2, a plurality of slits 212 are cut in the curtain element 202 extending from the lower end 208 toward the upper end 206 to define a plurality of curtain element strips 214. In embodiments, each curtain element strip 214 has a width W1 equal to or greater than 30 mm and less than or equal to 70 mm. In embodiments, each curtain element strip 214 has a width W1 equal to or greater than 40 mm and less than or equal to 60 mm. In embodiments, each curtain element strip 214 has a width W1 equal to or greater than 45 mm and less than or equal to 55 mm. In embodiments, the plurality of curtain element strips 214 extend perpendicular to a moving direction of the receiving conveyor 104. However, in other embodiments as described in more detail herein, the plurality of curtain element strips 214 extend at an oblique angle relative to the moving direction of the receiving conveyor 104.

Referring now to FIG. 3, another embodiment of an airflow curtain assembly 300 is depicted. The airflow curtain assembly 300 is similar to the airflow curtain assembly 200 of FIG. 2. Therefore, like reference numbers will be used to refer to like parts. The slits 212 cut into the curtain element 202 each have a width W2 greater than a width of each of the slits 212 cut into the curtain element 202 of FIG. 2. In embodiments, the slits 212 between adjacent curtain element strips 214 has a width W2 equal to or greater than 10 mm and less than or equal to 15 mm. In embodiments, the slits 212 between adjacent curtain element strips 214 has a width W2 equal to or greater than 10 mm and less than or equal to 25 mm. Accordingly, the width of each of the curtain element strips 214 is less than the width W1 of each of the curtain element strips 214 of FIG. 2. The curtain element strips 214 provide an open area of 30% +/- 10% for air to flow between the chute 106 (FIG. 1) and the airflow curtain assembly 300. The open area includes open area over the cargo 210 calculated at 25 mm clearance (load clearance) and side clearance around the airflow curtain assembly 300. In embodiments, the side clearance is greater than the load clearance to cause air to flow mostly around rather than under the airflow curtain assembly 300. All other features of the airflow curtain assembly 300 remain the same as that described herein with respect to the airflow curtain assembly 200 of FIG. 2.

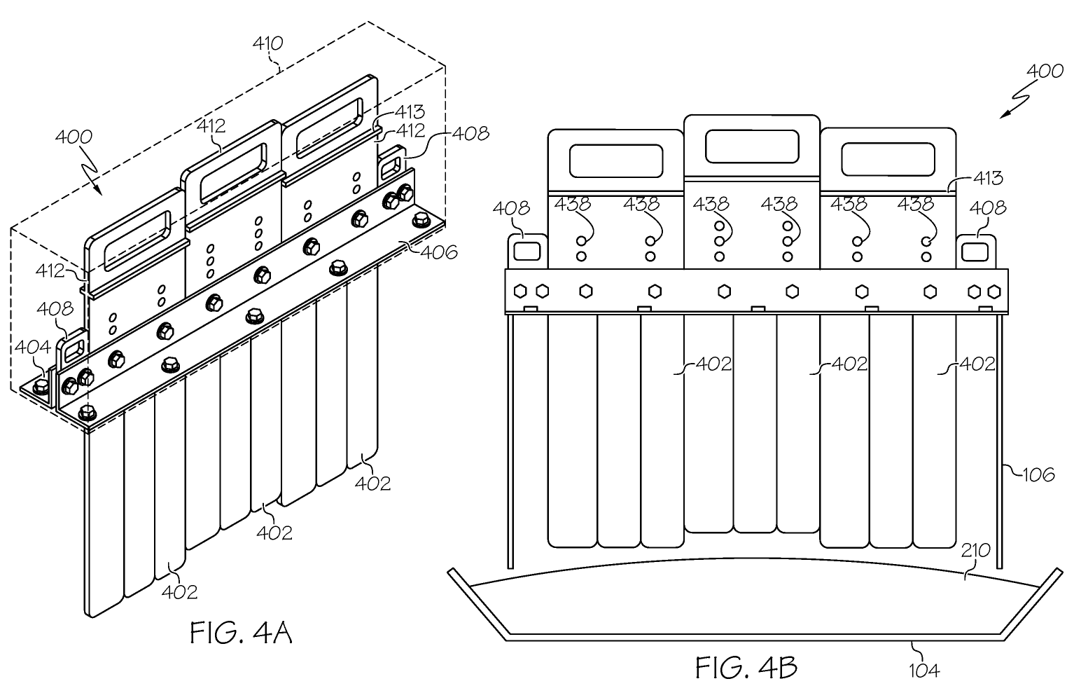

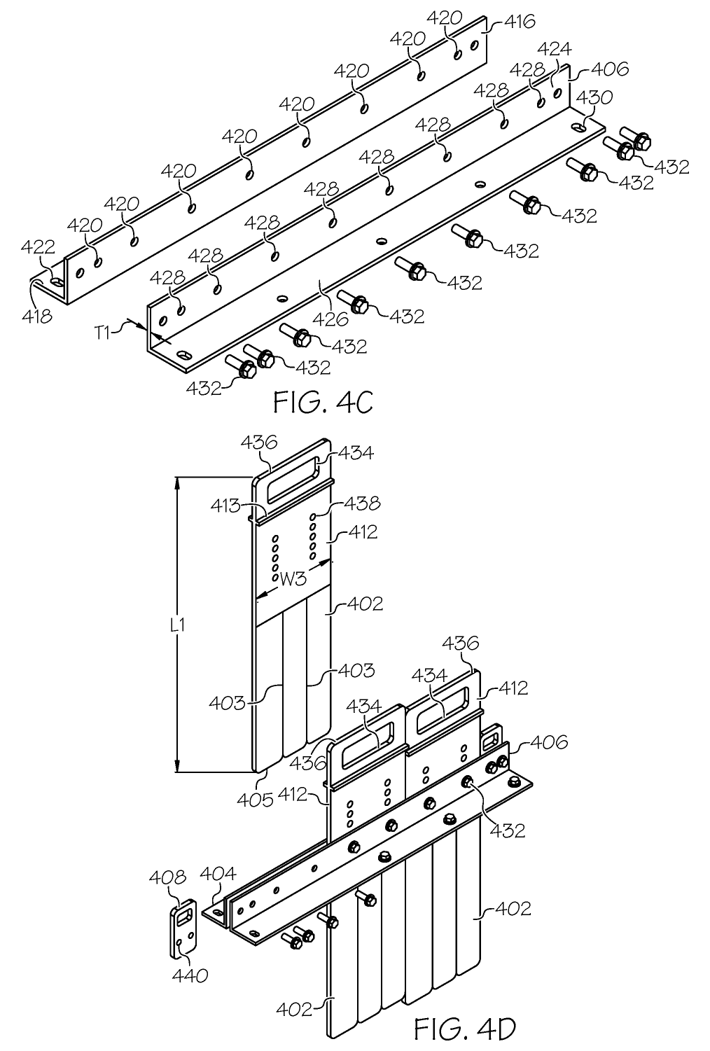

Referring now to FIG. 4A, another embodiment of an airflow curtain assembly 400 is depicted. The airflow curtain assembly 400 includes a plurality of curtain elements 402 provided between a fixed frame 404 and a movable frame 406, and a pair of end seals 408 provided between the fixed frame 404 and the movable frame 406 with the curtain elements 402 positioned between the end seals 408, and a cover 410 enclosing the end seals 408 and an upper portion 412 of the curtain elements 402. As shown, three curtain elements 402 are provided between the fixed frame 404 and the movable frame 406. However, it should be appreciated that any number of curtain elements 402 may be provided. The cover 410 is utilized to protect the curtain elements 402 from degradation resulting from effects of the local environment such as, for example, sunlight, ozone, heat, fumes, and the like. Although referred to herein as a “fixed” frame 404, it should be appreciated that the fixed frame 404 is movable, similar to the movable frame 406. In embodiments, the fixed frame 404 and the movable frame 406 are interchangeably fixed or moveable depending on access to the head of the bolts that restrain the curtain elements 402. In use, chute bolts may be sufficiently loosened to allow the moveable frame 406 to slide and, thereby permit inserting or removing the curtain elements 402 without taking the bolts the entire way out of the movable frame 406. During this process, the fixed frame 404 remains fixed in place. Additionally, in embodiments, nuts for attaching both the fixed frame 404 and the moveable frame 406 are welded to an underside of the cover 410 so that no access to the inside of the recirculation zone enclosure 118 is required. This provides ease of service as compared to conventional dust curtains.

As shown in FIG. 4B, the curtain elements 402 may terminate at a different vertical position. This may be due to the curtain elements 402 having different lengths or the curtain elements 402 being fixed to the fixed frame 404 and the movable frame 406 at different vertical positions. As described in more detail herein, a plurality of vertical adjustment slots 438 may be formed in each of the curtain elements 402 to fix the curtain elements 402 to the fixed frame 404 and the movable frame 406 at different vertical positions.

It should be appreciated that the above description of the airflow curtain assembly 300 of FIG. 3 is equally applicable to the airflow curtain assembly 400. For example, the curtain elements 402 may be formed from any suitable material such as, for example, rubber, cast polyurethane, high performance urethane or the like. The curtain elements 402 are flexible to accommodate overloaded cargo contacting the curtain elements 402 and avoid plugging.

As shown in FIG. 4C, the fixed frame 404 and the movable frame 406 are shown spaced apart from one another. The fixed frame 404 includes an upper wall 416 and a lower wall 418 extending from the upper wall 416. In embodiments, the upper wall 416 and the lower wall 418 extend substantially perpendicular to one another. A plurality of spaced apart apertures 420 are formed in the upper wall 416 of the fixed frame 404. A pair of holes 422 are formed at opposite ends of the lower wall 418 of the fixed frame 404. Additional intermediate slots may be formed in the fixed frame 404 to accommodate belts having wide widths.

Similarly, the movable frame 406 includes an upper wall 424 and a lower wall 426 extending from the upper wall 424. In embodiments, the upper wall 424 and the lower wall 426 extend substantially perpendicular to one another. A plurality of spaced apart apertures 428 are formed in the upper wall 424 of the movable frame 406. A pair of slots 430 are formed at opposite ends of the lower wall 426 of the movable frame 406. Additional intermediate slots may be formed in the movable frame 406 to accommodate belts having wide widths. The fixed frame 404 and the movable frame 406 may be formed from any suitable material such as, for example, steel, aluminum, plastic, or the like. In embodiments, the fixed frame 404 and the movable frame 406 each have a thickness T1 equal to or greater than 5 mm and less than or equal to 10 mm.

A plurality of fasteners 432 extend through respective apertures 428 formed in the movable frame 406 and respective apertures 420 formed in the fixed frame 404 to fix the fixed frame 404 and the movable frame 406 to one another. In embodiments, the fasteners 432 are bolts and, more specifically, 12 mm bolts. In embodiments, nuts are welded to the fixed frame 404 at each of the apertures 420 to engage the fasteners 432 when extended therethrough. The fasteners 432 and the nuts may be formed from any suitable material such as, for example, steel, stainless steel, plastic, and the like. Additionally, other fastener or retainer means are contemplated such as wedges, spring clips, set screws, and/or lynch pins.

As shown in FIG. 4D, the plurality of curtain elements 402 are shown being positioned between the fixed frame 404 and the movable frame 406. The curtain elements 402 are flat and have a substantially rectangular shape. The curtain elements 402 have a width W3 equal to or greater than 100 mm and less than or equal to 300 mm. In embodiments, the curtain elements 402 have a width W3 equal to or greater than 125 mm and less than or equal to 175 mm. In embodiments, the curtain elements 402 have a width W3 equal to or greater than 100 mm and less than or equal to 500 mm. In embodiments, the curtain elements 402 have a width W3 equal to or greater than 50 mm and less than or equal to 500 mm. The curtain elements 402 have any suitable length L2. In embodiments, the curtain elements 402 have a length L2 of 300 mm +/- 50 mm. In embodiments, the curtain elements 402 have a length L2 of 600 mm +/- 50 mm. In embodiments, the curtain elements 402 have a length L2 of 900 mm +/- 50 mm. However, other lengths are contemplated.

In embodiments, as shown, each curtain element 402 includes a handle opening 434 formed proximate an upper end 436 of the curtain elements 402 and a plurality of vertical adjustment slots 438 formed below the handle opening 434. However, it should be appreciated that one or more of the curtain elements 402 may not include the handle opening 434. The vertical adjustment slots 438 are vertically aligned in one or more linear arrays within the upper portion 412 of the curtain elements 402. It should be appreciated that each curtain element 402 may have any number of vertical adjustment slots 438 formed therein. The vertical adjustment slots 438 of each linear array are equidistantly spaced apart from one another. Additionally, in embodiments, as shown in FIG. 4B, the vertical adjustable slots 438 are arranged in a pair of linear arrays on each curtain element 402. However, it should be appreciated that the vertical adjustment slots 438 may be arranged in one column or more than two linear arrays. In embodiments, a distance between adjacent vertical adjustment slots 438 is 25 mm +/- 5 mm. The vertical position of the curtain elements 402 may be set by extending the fasteners 432 (FIG. 4C) through a particular vertical adjustment slot 438. Additionally, the curtain element 402 may include no slits 403, or one or more slits 403 formed therein and extending from a lower end 405 thereof opposite the upper end 436. As shown in FIG. 4B, each curtain element 402 includes a pair of slits 403. However, it should be appreciated that one or more than two slits 403 may be formed in each of the curtain elements 402. In embodiments, the curtain elements 402 each include a lip 413 formed below the handle opening 434 to inhibit the curtain elements 402 from falling between the fixed frame 404 and the movable frame 406. However, it should be appreciated that the spacing between adjacent slots 438 do not need to be equidistant from one another.

As shown in FIG. 4D, the end seals 408 are provided between the fixed frame 404 and the movable frame 406 and sandwich the curtain elements 402 therebetween. The end seals 408 prevent dust from entering between the fixed frame 404 and the movable frame 406. In embodiments, the end seals 408 are slotted to allow for tolerance stack-ups and expansion and contraction of the curtain elements 402. Each end seal 408 includes one or more holes 440 formed therein through which a respective fastener 432 extends to fix the end seals 408 in position between the fixed frame 404 and the movable frame 406. As shown in FIG. 4D, the end seals 408 each includes a pair of holes 440. Additionally, similar to the curtain elements 402, the end seals 408 include a handle opening 434 formed proximate the upper end 436 thereof. The end seals 408 are formed from a compressible material slightly thicker than the thickness of the curtain elements such as, for example, soft rubber, foamed rubber, polyurethane, or the like.

In operation, the fixed frame 404 and the movable frame 406 are mounted to an exterior surface of the recirculation zone enclosure 118 (FIG. 1). Accordingly, the curtain elements 402 may be removed from an exterior of the recirculation zone enclosure 118. Silicone caulk or a gasket material may be used to seal the fixed frame 404 and the movable frame 406 to the exterior surface of the recirculation zone enclosure 118. Likewise, the fixed frame 404 and the movable frame 406 may be mounted to an exterior surface of the discharge chute 108 (FIG. 1).

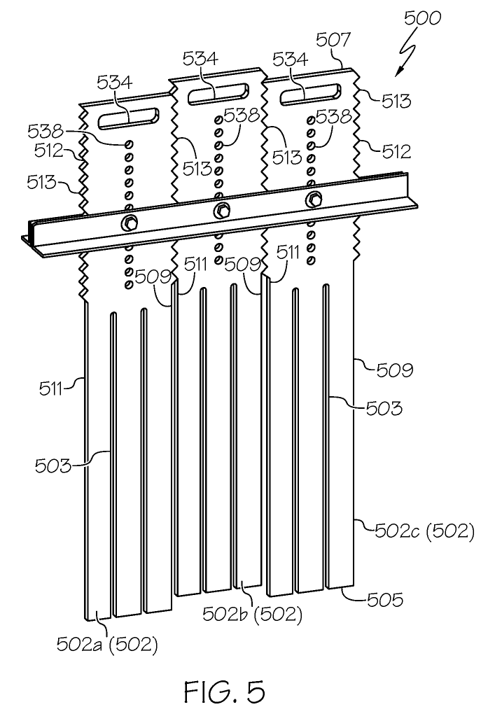

Referring now to FIG. 5, another embodiment of an airflow curtain assembly 500 is depicted. The airflow curtain assembly 500 is similar to the airflow curtain assembly 400 illustrated in FIG. 4A. Therefore, like reference numbers will be used to refer to like parts. Specifically, the airflow curtain assembly 500 includes a plurality of curtain elements 502 provided between the fixed frame 404 and the movable frame 406. Each curtain element 502 includes a handle opening 534 and the plurality of vertical adjustment slots 538 in one or more columns such as, for example, two columns, three columns, or more than three columns. Additionally, one or more slits 503 are formed in each of the curtain elements 502 extending from a lower end 505 of the curtain elements 502 toward an upper end 507 of the curtain elements 502. As shown, each curtain element 502 has a pair of slits 503 formed therein. However, any number of slits 503 may be formed in each of the curtain elements 502. It should be understood that the curtain elements 502 may not have any slits 503.

Referring still to FIG. 5, each curtain element 502 has a first side edge 509 and a second side edge 511 opposite the first side edge 509. The first side edge 509 and the second side edge 511 include teeth 513 defining serrated or undulating edges. The teeth 513 are provided within the upper portion 512 of the curtain elements 502 so as to not overlap the slits 503 in the vertical direction. As shown in FIG. 4, a middle curtain element 502b is translated upwardly in the vertical direction relative to side curtain elements 502a, 502c curtain such that the teeth 513 of adjacent curtain elements 502 mate with one another. Additionally, in embodiments in which the teeth 513 are provided, the end seals 408 (FIG. 4D) may have corresponding teeth to mate with the teeth 513 of the curtain elements 502. It should be appreciated that the side edges 509, 511 of the curtain elements 502 may have other designs apart from the teeth 513 to permit interlocking of adjacent curtain elements 502. However, it should be appreciated that the spacing between adjacent teeth 513 do not need to be equidistant from one another.

Referring now to FIG. 6, another embodiment of a curtain element 602 is depicted provided between a fixed frame 604 and a movable frame 606. Specifically, a pair of curtain elements 602 are depicted as being positioned between the fixed frame 604 and the movable frame 606. It should be appreciated that the above description of the curtain elements 402 is equally applicable to the curtain elements 602. However, rather than the curtain element 602 including the handle opening 434 and the vertical adjustment slots 438 of the curtain element 402 described herein and depicted in FIG. 4D, the curtain element 602 includes a handle 635 formed at an upper end 636, and a plurality of ribs 638 extending from a front surface 639 of the curtain element 602. Additionally, although not shown, in embodiments, the curtain element 602 includes a plurality of ribs 638 extending from a rear surface 640 opposite the front surface 639 of the curtain element 602.

In particular, the handle 635 extends from the upper end 636 in opposite directions parallel to a plane defined by the front surface 639 and the rear surface 640 of the curtain element 602. The handle 635 facilitates lifting of the curtain element 602 and prevents the curtain element 602 from falling into the recirculation zone enclosure 118 (FIG. 1) during service. Additionally, in embodiments, the ribs 638 extend from the front surface 639 below the handle 635.

The ribs 638 are vertically aligned in one or more linear arrays within an upper portion 612 of the curtain elements 602. It should be appreciated that each curtain element 602 may have any number of ribs 638 formed therein. The ribs 638 of each linear array are equidistantly spaced apart from one another. Additionally, in embodiments, as shown in FIG. 6, the ribs 638 are arranged in a single linear array on each curtain element 602. However, it should be appreciated that the ribs 638 may be arranged in more than one linear array. In embodiments, a distance between adjacent ribs 638 is 25 mm +/- 5 mm. However, it should be appreciated that the spacing between adjacent ribs 638 do not need to be equidistant from one another.

Referring still to FIG. 6, the fixed frame 604 and the movable frame 606 are depicted. It should be appreciated that the fixed frame 604 and the movable frame 606 include similar structure to the fixed frame 404 and the movable frame 406 described herein. However, as shown in FIG. 6, one or more slots 628 are formed in the movable frame to receive a respective rib 638 based on a vertical position of the curtain element 602. As shown in FIG. 6, the movable frame 606 includes a slot 628 formed therein to receive a respective rib 638 of a pair of curtain elements 602. It should be appreciated that the fixed frame 604 includes similar structure as the movable frame 606.

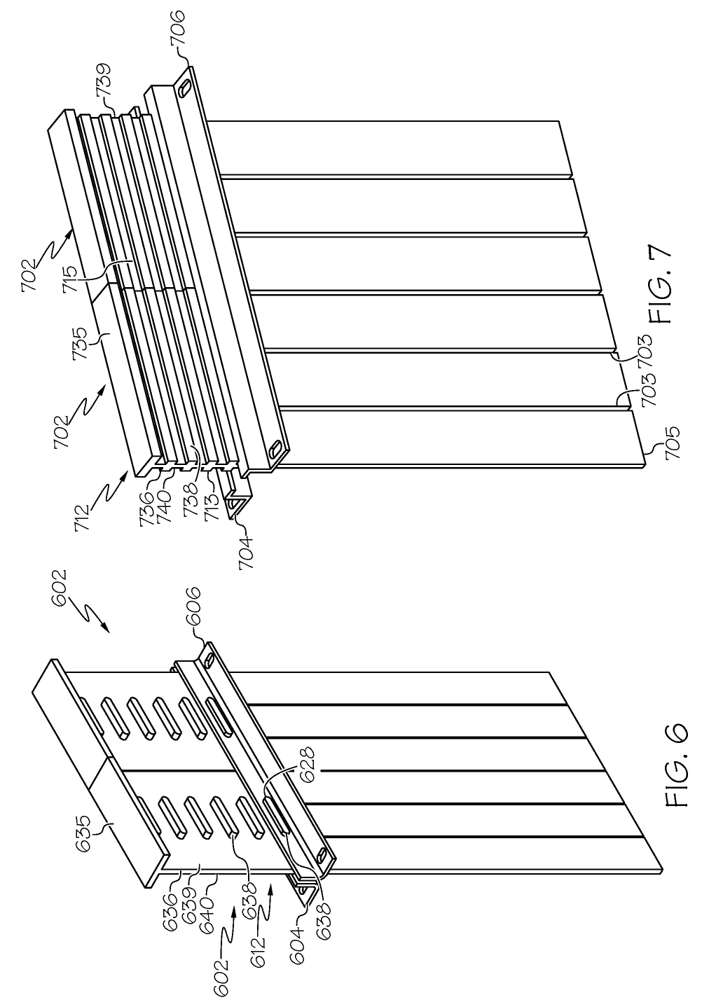

Referring now to FIG. 7, another embodiment of a curtain element 702 is depicted provided between a fixed frame 704 and a movable frame 706. Specifically, a pair of curtain elements 702 are depicted as being positioned between the fixed frame 704 and the movable frame 706. It should be appreciated that the above description of the curtain elements 402 is equally applicable to the curtain elements 702.

Each curtain element 702 includes an upper portion 712 extending from an upper end 736 of the curtain elements 702 toward a lower end 705 opposite the upper end 736. The curtain element 702 includes a handle 735 formed at the upper end 736, and a plurality of ribs 738 extending from a front surface 739 of the curtain element 702 within the upper portion 712. Additionally, in embodiments, the curtain element 702 includes a plurality of ribs 738 extending from a rear surface 740 opposite the front surface 739 of the curtain element 702.

In particular, the handle 735 extends from the upper end 736 in opposite directions parallel to a plane defined by the front surface 739 and the rear surface 740 of the curtain element 702. The handle 735 facilitates lifting of the curtain element 702 and prevents curtain elements from falling into the recirculation zone enclosure (FIG. 1) during service. Additionally, in embodiments, the ribs 738 extend from the front surface 739 below the handle 735. In embodiments, as shown in FIG. 7, the ribs 738 extend between opposite sides 713, 715 of the curtain element 702. In other embodiments, the ribs 738 terminate prior to the sides 713, 715 of the curtain element 702. It should be appreciated that each curtain element 702 may have any number of ribs 738 formed therein. The ribs 738 are equidistantly spaced apart from one another. In embodiments, a distance between adjacent ribs 738 is 25 mm +/- 5 mm.

In embodiments, the curtain element 702 includes one or more slits 703 formed therein and extending from the lower end 705. As shown in FIG. 7, each curtain element 702 includes a pair of slits 703. However, it should be appreciated that none, one, or more than two slits 703 may be formed in each of the curtain elements 702.

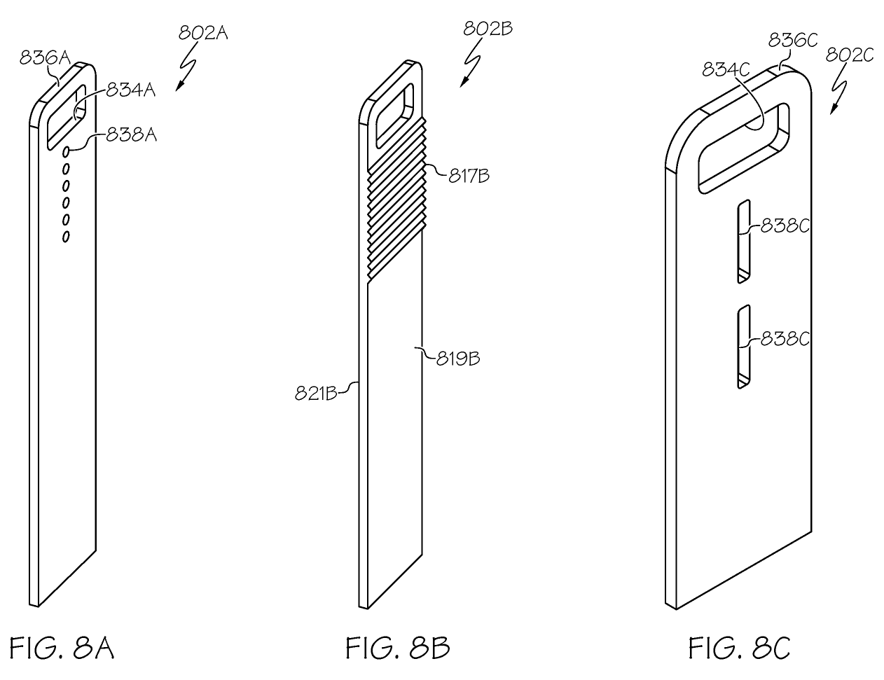

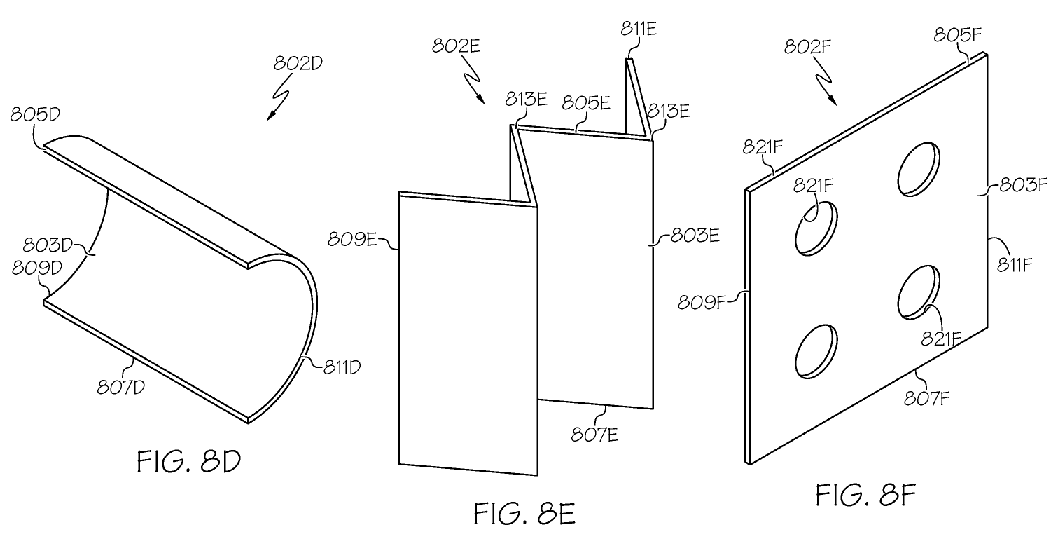

Referring now to FIG. 8A, another embodiment of a curtain element 802A is depicted. It should be appreciated that the above description of the curtain element 402 of FIG. 4A is equally applicable to the curtain element 802A. Specifically, a plurality of vertical adjustment slots 838A may be formed in the curtain element 802A. However, contrary to the curtain element 402 in which the vertical adjustment slots 438 are arranged in a pair of linear arrays, the vertical adjustment slots 838A are arranged in a single linear array. Additionally, contrary to the curtain element 402 including a pair of slits 403, no slits are formed in the curtain element 802A. Lastly, the curtain element 802A includes a handle opening 834A formed proximate an upper end 836A of the curtain element 802A and the plurality of vertical adjustment slots 838A formed below the handle opening 834A. However, it should be appreciated that curtain element 802A may not include the handle opening 834A.

Referring now to FIG. 8B, another embodiment of a curtain element 802B is depicted. Rather than forming the vertical adjustment slots 838A in the curtain element 802B, the curtain element 802B includes a plurality of teeth 817B formed on a front surface 819B of the curtain element 802B. Although not shown, the teeth 817B mate with corresponding teeth formed on an inner surface of the movable frame 406 (FIG. 4D) to set a vertical position of the curtain element 802B. Additionally, in embodiments, additional teeth may be formed on a rear surface 821B of the curtain element 802B opposite the front surface 819B and mate with corresponding teeth formed on an inner surface of the fixed frame 404 (FIG. 4D) to set the vertical position of the curtain element 802B.

Referring now to FIG. 8C, another embodiment of a curtain element 802C is depicted. Similar to the curtain element 802A having the plurality of vertical adjustment slots 838A formed therein, each having a generally circular shape, the curtain element 802C includes a plurality of vertical adjustment slots 838C formed therein having an elongated shape extending in a longitudinal direction. Although only a pair of vertical adjustment slots 838C are shown formed in the curtain element 802C, it should be appreciated that any number of vertical adjustment slots 838C may be formed in the curtain element 802C, for example, one or more than two vertical adjustment slots 838C. In embodiments, in which a plurality of vertical adjustment slots 838C are formed in the curtain element 802C, the vertical adjustment slots 838C may be equidistantly spaced apart from one another. Additionally, it should be appreciated that, when a plurality of vertical adjustment slots 838C are formed in the curtain element 802C, the vertical adjustment slots 838C may be arranged in one or more linear arrays. Lastly, the curtain element 802C includes the handle opening 834C formed proximate an upper end 836C of the curtain element 802C.

Referring now to FIG. 8D, another embodiment of a curtain element 802D is depicted. The curtain element 802D includes a body 803D having an upper end 805D, a lower end 807D opposite the upper end, a first side edge 809D, and a second side edge 811D opposite the first side edge 809D. The first side edge 809D and the second side edge 811D extend between the upper end 805D and the lower end 807D. As with the curtain element 202 disclosed herein and illustrated in FIG. 2, the curtain element 802D may be formed from any suitable material such as, for example, rubber, cast polyurethane, high performance urethane, or the like, and may be molded or water jet cut. Accordingly, as shown in FIG. 8D, the curtain element 802D is flexible and capable of bending at any suitable location along the body 803D. In embodiments, the curtain element 802D is a one-piece, monolithic structure with no slits, cuts, or the like formed in the body 803D.

Referring now to FIG. 8E, another embodiment of a curtain element 802E is depicted. The curtain element 802E includes a body 803E having an upper end 805E, a lower end 807E opposite the upper end, a first side edge 809E, and a second side edge 811E opposite the first side edge 809E. The first side edge 809E and the second side edge 811E extend between the upper end 805E and the lower end 807E. As with the curtain element 802D disclosed herein and illustrated in FIG. 8D, the curtain element 802E may be formed from any suitable material such as, for example, rubber, cast polyurethane, high performance urethane, or the like, and may be molded or water jet cut. Accordingly, as shown in FIG. 8E, the curtain element 802E is flexible and capable of bending at any suitable location along the body 803E. Specifically, the curtain element 802E is capable of folding into a tri-fold or quad-fold configuration. In doing so, the body 803E may include one or more delineations 813E that permit the body 803E to be easily folded. In embodiments, the delineations 813E extend parallel to one another between the upper end 805E and the lower end 807E of the body 803E. In other embodiments, the delineations 813E extend parallel to one another between the first side edge 809E and the second side edge 811E of the body 803E. In embodiments, the curtain element 802E is a one-piece, monolithic structure with no slits, cuts, or the like formed in the body 803E.

Referring now to FIG. 8F, another embodiment of a curtain element 802F is depicted. The curtain element 802F includes a body 803F having an upper end 805F, a lower end 807F opposite the upper end, a first side edge 809F, and a second side edge 811F opposite the first side edge 809F. The first side edge 809F and the second side edge 811F extend between the upper end 805F and the lower end 807F. As with the curtain element 802D disclosed herein and illustrated in FIG. 8D, the curtain element 802F may be formed from any suitable material such as, for example, rubber, cast polyurethane, high performance urethane, or the like, and may be molded or water jet cut. Accordingly, the curtain element 802F is flexible and capable of bending at any suitable location along the body 803F. In embodiments, the curtain element 802F is a one-piece, monolithic structure with no slits, cuts, or the like formed in the body 803F. In embodiments, one or more holes 821F are formed in the body 803F of the curtain element 802F. As shown in FIG. 8F, four holes 821F are formed in the body 803F. However, it should be appreciated that any number of holes 821F may be formed in the body 803F and arranged in any suitable arrangement. Additionally, the holes 821F may be formed within the body 803F at any suitable location other than that depicted herein.

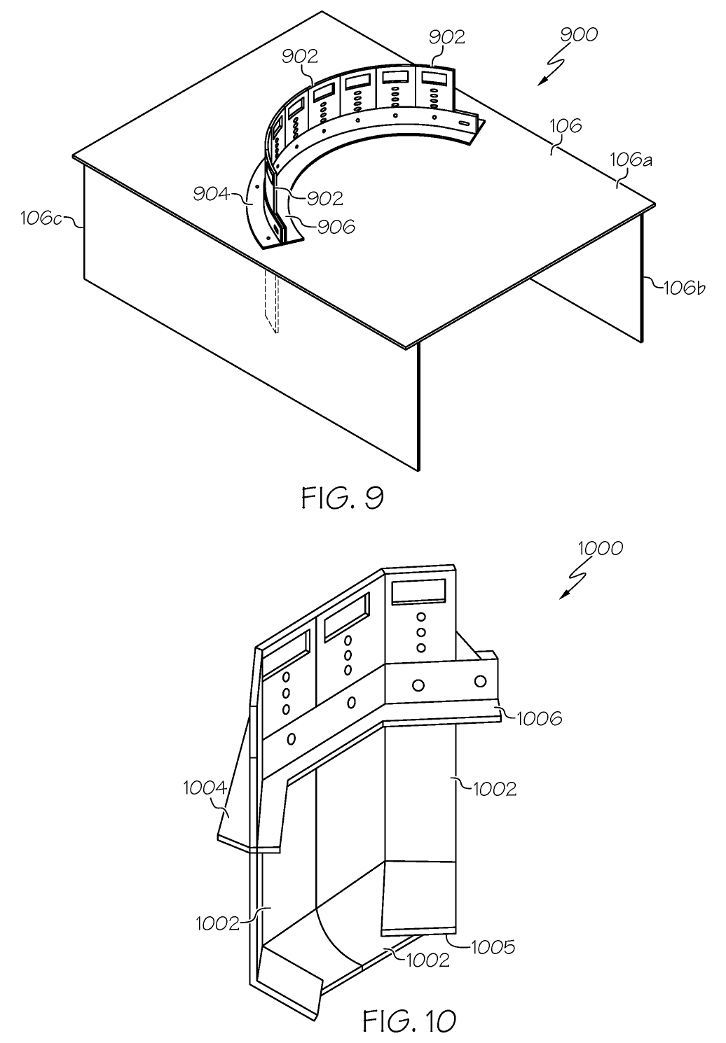

Referring now to FIG. 9, another embodiment of an airflow curtain assembly 900 is depicted. The airflow curtain assembly 900 is similar to the airflow curtain assembly 400 of FIG. 4A. However, the airflow curtain assembly 900 includes a plurality of curtain elements 902, a fixed frame 904, and a movable frame 906 each having a curved profile. As shown, the curtain elements 902 extend through the chute 106, and the fixed frame 904 and the movable frame 906 are mounted to an exterior 106a of the chute 106, as described herein, such that the curtain elements 902 may be accessible and removed from the exterior 106a of the chute 106. In embodiments, the curtain elements 902, the fixed frame 904, and the movable frame 906 are curved to face a downstream end 106b of the chute 106, as shown. In other embodiments, the curtain elements 902, the fixed frame 904, and the movable frame 906 are curved to face an upstream end 106c of the chute 106. The curved profile of the curtain elements 902, the fixed frame 904, and the movable frame 906 assists in controlling the flow of air and dust flowing through the chute 106.

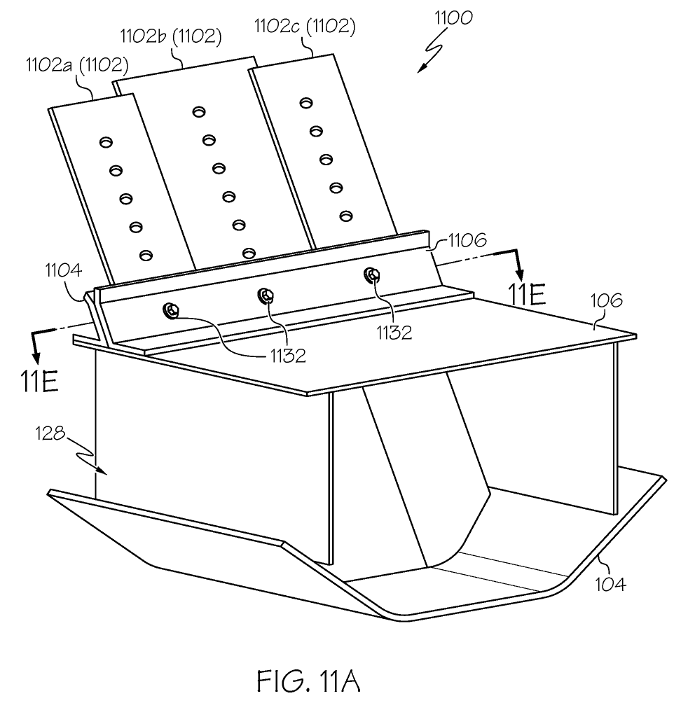

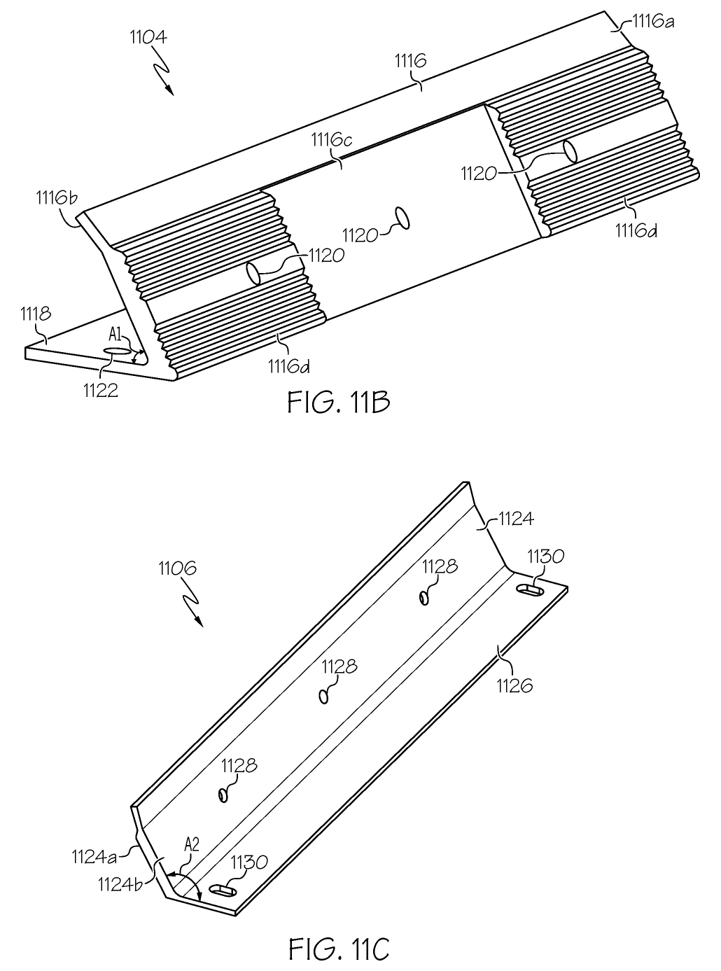

Referring now to FIG. 10, another embodiment of an airflow curtain assembly 1000 is depicted. The airflow curtain assembly 1000 is similar to the airflow curtain assembly 900 of FIG. 9. However, the airflow curtain assembly 1000 includes a plurality of curtain elements 1002, a fixed frame 1004, and a movable frame 1006. The fixed frame 1004 and the movable frame 1006 each have a segmented, angled profile rather than the curved profile of the airflow curtain assembly 900 depicted in FIG. 9. Additionally, a lower end 1005 of the curtain elements 1002 are either curved or angled in a downstream direction. In embodiments, the lower end 1005 of each of the curtain elements 1002 are curved. In other embodiments, the lower end 1005 of each of the curtain elements 1002 are angled. It should be appreciated that the curtain elements 1002, similar to the other curtain elements described herein, may contact an upper surface of the belt in a manner to create a one-way valve that prevents material from rolling back out of a tail box. However, the material placed on the belt is permitted to pass into an enclosure. Such material may include material shoveled onto the belt or accumulations of snow and/or ice.

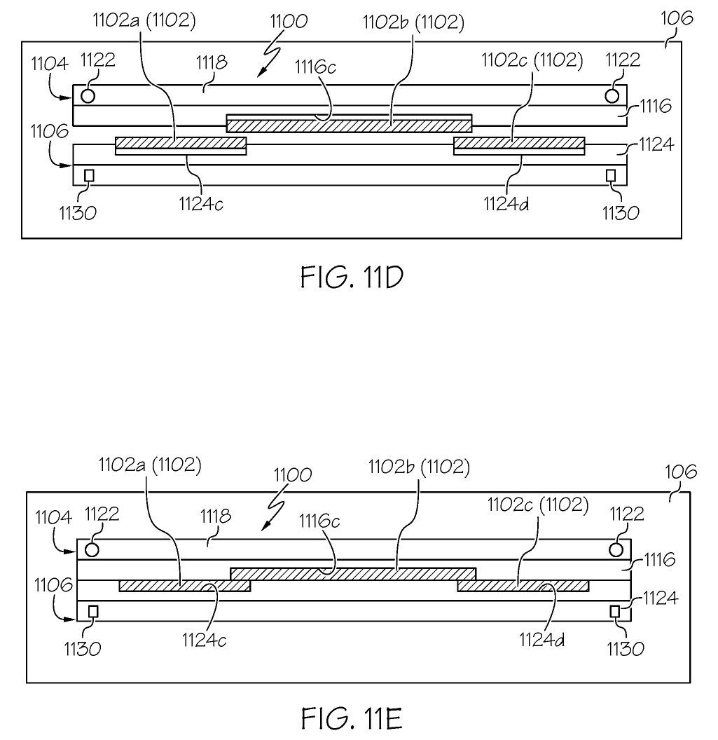

Referring now to FIG. 11A, another embodiment of an airflow curtain assembly 1100 is depicted. Specifically, the airflow curtain assembly 1100 includes a plurality of curtain elements 1102, a fixed frame 1104, and a movable frame 1106. The curtain elements 1102 are provided between the fixed frame 1104 and the movable frame 1106 and fixed therebetween by a plurality of fasteners 1132. It should be appreciated that the curtain elements 1102 may include any suitable embodiment of curtain elements described herein. As shown, the plurality of curtain elements 1102 are arranged to overlap one another. Specifically, the curtain elements 1102 include a pair of side curtain elements 1102a, 1102c that overlap a center curtain element 1102b. However, other arrangements of overlapping the curtain elements 1102 is contemplated. Additionally, as described in more detail herein, the fixed frame 1104 and the movable frame 1106 are formed to permit the curtain elements 1102 to extend at an oblique angle into the chute 106 relative to the moving direction of the receiving conveyor 104. Due to the angular orientation of the curtain elements 1102 relative to the receiving conveyor 104, the airflow curtain assembly 1100 is particularly suited for being used within the tail box 128 of the chute 106 to inhibit cargo, dust, and/or air from moving in an opposite direction.

Referring now to FIG. 11B, the fixed frame 1104 of the airflow curtain assembly 1100 is depicted. The fixed frame 1104 includes an upper wall 1116 and a lower wall 1118 extending from the upper wall 1116 at an oblique angle A1. In embodiments, the oblique angle A1 is equal to or less than 80 degrees and greater than or equal to 10 degrees. In embodiments, the oblique angle A1 is equal to or less than 70 degrees and greater than or equal to 45 degrees. The upper wall 1116 includes an inner surface 1116a and an outer surface 1116b opposite the inner surface 1116a. In embodiments, an upper portion of the upper wall 1116 opposite the lower wall 1118 extends at an oblique angle relative to the rest of the upper wall 1116 to provide a clearance for inserting the curtain elements. In embodiments, a center recess 1116c is formed in a center of the inner surface 1116a of the upper wall 1106 corresponding to a position of the center curtain element 1102b (FIG. 11A). In embodiments, a plurality of teeth 1116dare formed on the inner surface 1016a of the upper wall 1116 on opposite sides of the center recess 1116c. A plurality of spaced apart apertures 1120 are formed in the upper wall 1116 to secure the curtain elements 1102 to the upper wall 1116 by fasteners, as described herein. One or more holes 1122 are formed in the lower wall 1118 to receive a fastener and fix the fixed frame 1104 to the chute 106 (FIG. 11A).

Referring now to FIG. 11C, the movable frame 1106 of the airflow curtain assembly 1100 is depicted. The movable frame 1106 includes an upper wall 1124 and a lower wall 1126 extending from the upper wall 1124 at an oblique angle A2. In embodiments, the oblique angle A2 is equal to or less than 170 degrees and greater than or equal to 110 degrees. In embodiments, the oblique angle A2 is equal to or less than 135 degrees and greater than or equal to 110 degrees. The upper wall 1124 includes an inner surface 1124a and an outer surface 1124b opposite the inner surface 1124a. As shown in FIG. 11D, a first side recess 1124c and a second side recess 1124d are formed in the inner surface 1124a of the upper wall 1124 corresponding to a position of the center curtain element 1102b (FIG. 11A). Referring again to FIG. 11C, a plurality of spaced apart apertures 1128 are formed in the upper wall 1124 to secure the curtain elements 1102 to the upper wall 1124 by fasteners, as described herein. In embodiments, an upper portion of the upper wall 1124 opposite the lower wall 1126 extends at an oblique angle relative to the rest of the upper wall 1124 to provide a clearance for inserting the curtain elements. One or more slots 1130 are formed in the lower wall 1126 to receive a fastener (not shown) and fix the movable frame 1106 to the chute 106 (FIG. 11A). As shown a pair of slots 1130 are formed in opposite ends of the lower wall 1126 of the movable frame 1106. The slots 1130 have an elongated shape to permit movement of the movable frame 1106 relative to the fixed frame 1104, as described in more detail herein.

Referring again to FIG. 11D, a plan view of the airflow curtain assembly 1100 in an unassembled state is depicted. Specifically, the curtain elements 1102 are shown positioned between the fixed frame 1104 and the movable frame 1106, which are spaced apart from one another. The center curtain element 1102b is positioned within the center recess 1116c formed in the fixed frame 1104, and the side curtain elements 1102a, 1102c are positioned within respective side recesses 1124c, 1124d formed in the movable frame 1106. A fastener (not shown) is positioned within each of the holes 1122 formed in the lower wall 1118 of the fixed frame 1104, and a fastener (not shown) is positioned within each of the slots 1130 formed in the lower wall 1126 of the movable frame 1106 to secure the fixed frame 1104 and the movable frame 1106 to the chute 106 (FIG. 1). Thereafter, the movable frame 1106 is permitted to move closer to the fixed frame 1104 to sandwich the curtain elements 1102 therebetween due to the fasteners being permitted to translate within the slots 1130.

Referring now to FIG. 11E, a plan view of the airflow curtain assembly 1100 in an assembled state is depicted. Once the curtain elements 1102 and the movable frame 1106 are in the proper position, the fasteners extending through the slots 1130 formed in the lower wall 1126 of the movable frame 1106 are further engaged with the chute 106 (FIG. 1) to maintain a position of the movable frame 1106 relative to the fixed frame 1104 and the chute 106.

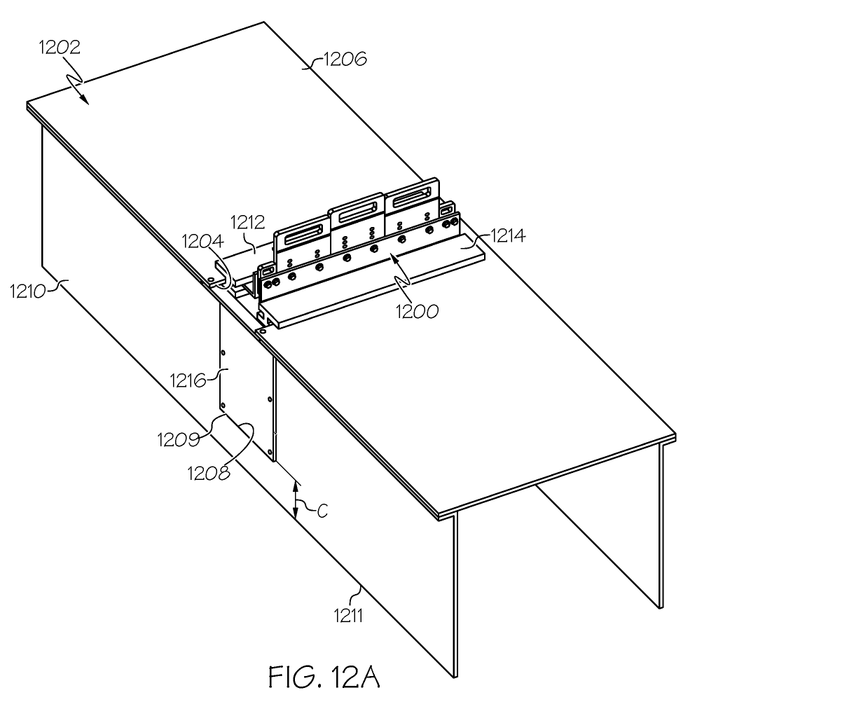

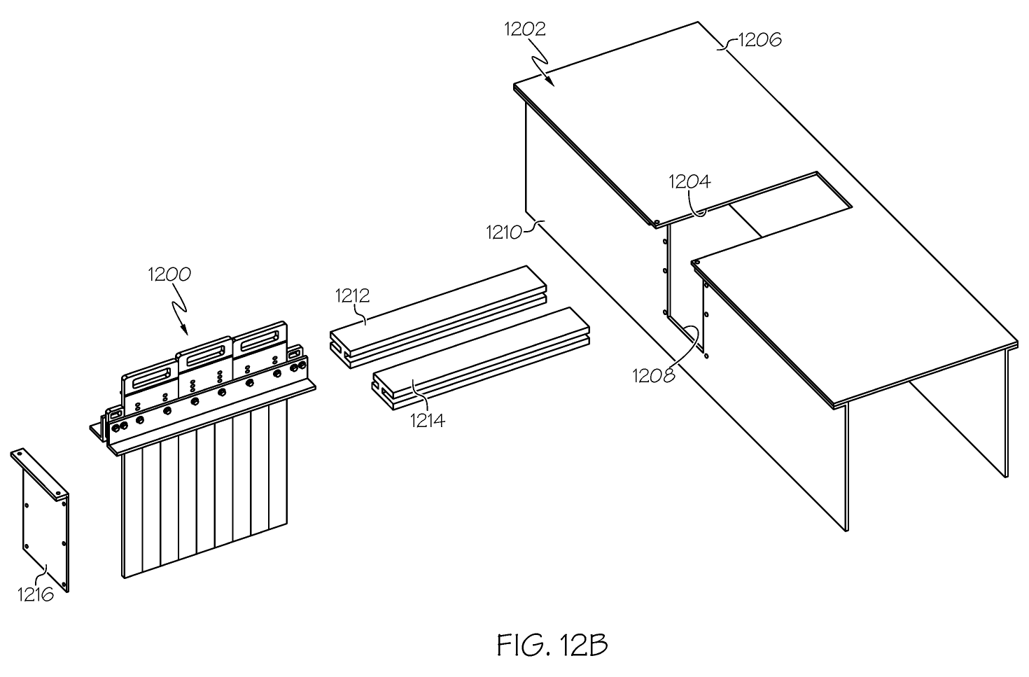

Referring now to FIGS. 12A and 12B, another embodiment of an airflow curtain assembly 1200 is depicted positioned within a chute 1202. The airflow curtain assembly 1200 is similar to the airflow curtain assembly 400 depicted in FIG. 4A. Accordingly, like reference numbers are used to refer to like parts. As shown in FIG. 12A, the airflow curtain assembly 1100 is shown positioned partially within and mounted to the chute 1202. As shown in FIG. 12B, the airflow curtain assembly 1100 is shown removed from the chute 1202.

The chute 1202 includes an upper opening 1204 formed in an upper wall 1206 of the chute 1202, and a side opening 1208 formed in a side wall 1210 of the chute 1202 or, in embodiments, a skirtboard. A clearance distance C is defined between a lower edge 1209 of the side opening 1208 and a lower edge 1211 of the side wall 1210. The upper opening 1204 and the side opening 1208 form a continuous opening extending along the upper wall 1206 and the side wall 1210 of the chute 1202. A first track extrusion 1212 is positioned on a first lateral edge defining the upper opening 1204, and a second track extrusion 1214 is positioned on a second lateral edge defining the upper opening 1204 opposite the first track extrusion 1212. The first track extrusion 1212 and the second track extrusion 1214 are removably mounted to the upper wall 1206 of the chute 1202 and the airflow curtain assembly 1200 itself by any suitable means, such as fasteners or the like.

As shown in FIG. 12A, with the airflow curtain assembly 1200 positioned within the upper opening 1204, the first track extrusion 1212 and the second track extrusion 1214 are positioned on opposite sides of the airflow curtain assembly 1200. Accordingly, the airflow curtain assembly 1200 is sandwiched between the first track extrusion 1212 and the second track extrusion 1214 and secured to the upper wall 1206 of the chute 1202. In embodiments, a sealing member may be positioned between the first track extrusion 1212 and the second track extrusion 1214 around the airflow curtain assembly 1200 to prevent airflow through the upper opening 1204. A cover 1216 is positioned at the side opening 1208 of the chute 1202 to further retain the airflow curtain assembly 1200 within the chute 1202. The cover 1216 may be removably attached to the side wall 1210 of the chute 1202 by any suitable means, such as fasteners or the like.

As shown in FIG. 12B, the airflow curtain assembly 1200 may be removed from the chute 1202 by initially removing the cover 1216 from the side wall 1210, subsequently removing the first track extrusion 1212 and the second track extrusion 1214, and subsequently removing the airflow curtain assembly 1200 from the chute 1202 by sliding the airflow curtain assembly 1200 through the side opening 1208. Once removed, the airflow curtain assembly 1200 may be serviced. Once servicing is completed, the airflow curtain assembly 1200 may be reinstalled by inserting the airflow curtain assembly 1200 through the side opening 1208 and into the upper opening 1204 of the chute 1202, reattaching the first track extrusion 1212 and the second track extrusion 1214 to the upper wall 1206 of the chute 1202, and reattaching the cover 1216 to the side opening 1208. Alternatively, the first track extrusion 1212 and the second track extrusion 1214 may remain fixed and simply the curtain elements of the airflow curtain assembly 1200 is withdrawn.

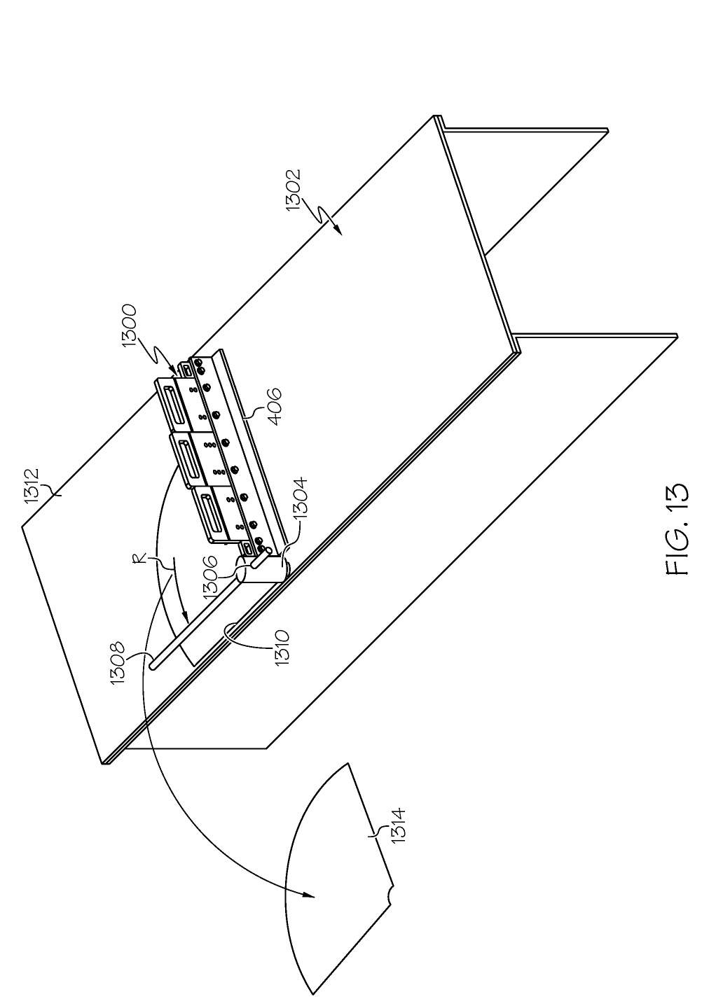

Referring now to FIG. 13, another embodiment of an airflow curtain assembly 1300 is depicted as being partially positioned within a chute 1302. The airflow curtain assembly 1200 is similar to the airflow curtain assembly 400 depicted in FIG. 4A. Accordingly, like reference numbers are used to refer to like parts. Rather than completely removing the airflow curtain assembly 1300 from the chute 1302 for servicing, as described with respect to other embodiments discussed herein, the airflow curtain assembly 1300 rotates within the chute 1302 for servicing. Specifically, the movable frame 406 of the airflow curtain assembly 1300 is fixed to an upper wall of the chute 1302. The airflow curtain assembly 1300 further includes a capstan 1304 fixed to the fixed frame (not shown) of the airflow curtain assembly 1300. The capstan 1304 has a hole 1306 formed therein for receiving a lever 1308.

The chute 1302 includes an upper opening 1310 formed in an upper wall 1312 of the chute 1302. In embodiments, as shown, the upper opening 1310 has a semicircular shape. However, the upper opening 1310 may have any suitable shape. A cover 1314 is positionable over the upper opening 1310 and securable to the upper wall 1312 in any suitable manner, such as by using one or more fasteners or the like. The cover 1314 has a shape corresponding to the shape of the upper opening 1310.

To position the airflow curtain assembly 1300 for servicing, the cover 1314 is removed from the upper opening 1310, as shown in FIG. 13. Subsequently, the lever 1308 is inserted into the hole 1306 formed in the capstan 1304 and rotated in the direction of arrow R, thereby rotating the airflow curtain assembly 1300 from a use position, as shown in FIG. 13, to a servicing position within the upper opening 1310. The movable frame 406 does rotate with the rest of the airflow curtain assembly 1200. Accordingly, curtain elements of the airflow curtain assembly 1300 are accessible. In embodiments, the airflow curtain assembly 1300 is rotated 90 degrees in the direction of arrow R such that the curtain elements of the airflow curtain assembly 1300 may be serviced. Once servicing is completed, the airflow curtain assembly 1300 may be rotated in a direction opposite the direction of arrow R back into the use position shown in FIG. 13 by rotating the capstan 1304 via the lever 1308, and reattaching the cover 1314 to the upper opening 1310.

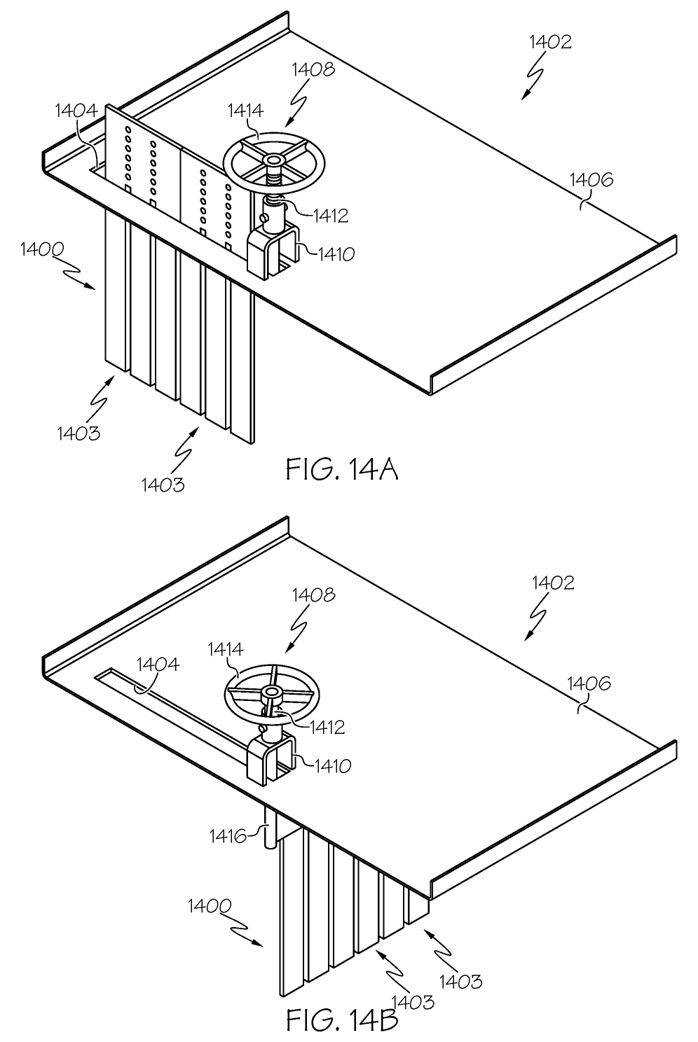

Referring now to FIGS. 14A and 14B, another embodiment of an airflow curtain assembly 1400 is depicted as being partially positioned relative to a chute 1402. The airflow curtain assembly 1400 includes one or more curtain elements 1403 and it should be appreciated that the curtain elements 1403 may be any suitable curtain element described herein other than that specifically illustrated in FIGS. 14A and 14B. An opening 1404 is formed in an upper wall 1406 of the chute 1402. The chute 1402 includes a rotating assembly 1408 extending through the opening 1404. The rotating assembly 1408 includes a frame 1410 fixed to the upper wall 1406 of the chute 1402, a shaft 1412 extending through the frame 1410 and rotatable within the frame 1410, a rotating element 1414 fixed to an upper end of the shaft 1412, and an arm 1416 (FIG. 14B) extending from an opposite lower end of the shaft 1412. In embodiments, the arm 1416 extends perpendicular to the shaft 1412.

As shown in FIG. 14A, the curtain elements 1403 are inserted into the chute 1402 through the opening 1404 formed in the upper wall 1406 of the chute 1402. Thereafter, the curtain elements 1403 are fixed to the arm 1416, shown in FIG. 14B. Once the curtain elements 1403 are positioned within the chute 1402 and fixed to the arm 1416, the rotating element 1414 may be operated to rotate the shaft 1412 and the arm 1416. Accordingly, rotation of the rotating element 1414 in a first direction rotates the curtain elements 1403 between an open position in which the curtain elements 1403 are not impeding airflow through the chute 1402, and a closed position, as shown in FIG. 14B, in which the curtain element 1403 do impede airflow through the chute 1402. In order to service the curtain elements 1403, the rotating element 1414 is rotated in an opposite second direction to move the curtain elements 1403 back into the open position. In embodiments, a cover is provided to seal the opening 1404.

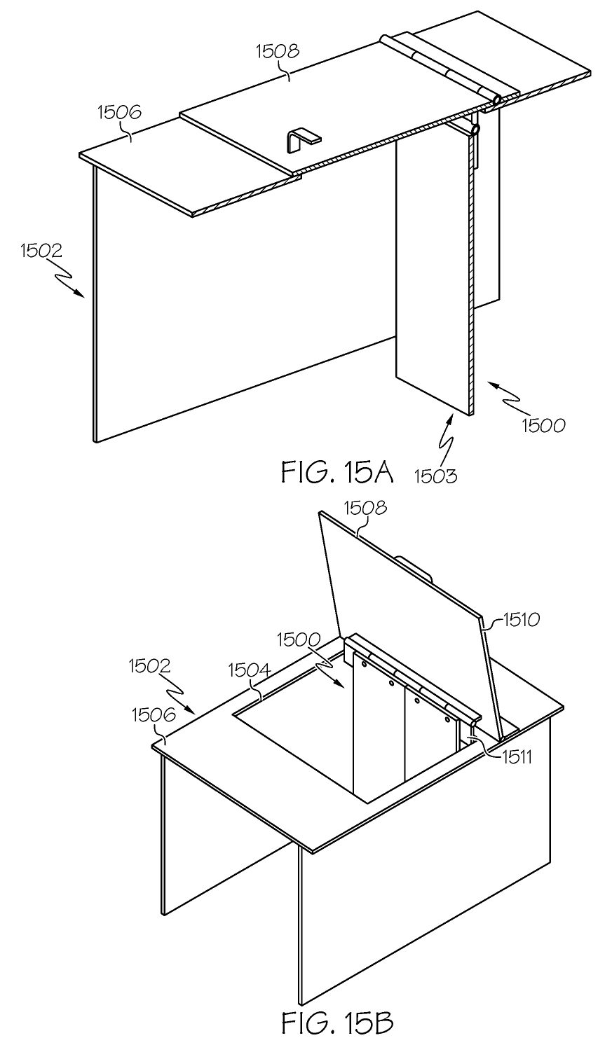

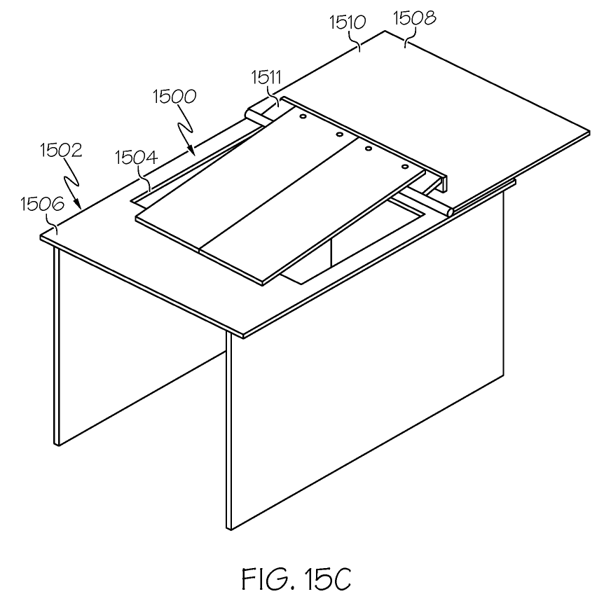

Referring now to FIGS. 15A-15C, another embodiment of an airflow curtain assembly 1500 is depicted as being partially positioned relative to a chute 1502. The airflow curtain assembly 1500 includes one or more curtain elements 1503 and it should be appreciated that the curtain elements 1503 may be any suitable curtain element described herein other than that specifically illustrated in FIGS. 15A and 15B. An opening 1504 is formed in an upper wall 1506 of the chute 1502. The chute 1502 includes a door 1508 pivotally attached to the upper wall 1506 of the chute 1502 over the opening 1504. The curtain elements 1503 are pivotally attached to a lower surface 1510 of the door 1508 by a flap 1511.

As shown in FIG. 15A, the door 1508 is shown in a closed position against the opening 1504 formed in the chute 1502. Additionally, the curtain elements 1503 are shown in the inserted position hanging from the door 1508 and extending into an interior of the chute 1502. In order to service the curtain elements 1503, the door 1508 is raised relative to the opening 1504, which exposes the opening 1504, as shown in FIG. 15B. The door 1508 continues to rotate from the closed position into an open position, as shown in FIG. 15C, and against the upper wall 1506 of the chute 1502. Rotating the door 1508 into the open position draws the curtain elements 1503 out of the chute 1502 and allows the curtain elements 1503 to rest on the upper wall 1506 of the chute 1502. With the curtain elements 1503 removed from the chute 1502, the curtain elements 1503 may be detached from the door 1508, and specifically the flap 1511 pivotally attached to the door 1508, such that the curtain elements 1503 may be serviced. Thereafter, the curtain elements 1503 are rotated back into the interior of the chute 1502 and the door 1508 is rotated back into the closed position, as shown in FIG. 15A. In embodiments, the curtain elements 1503 can have a plurality of rows of adjustment holes similar to those depicted in FIGS. 4 and 8A. Additionally, in embodiments, the curtain elements 1503 may have slits formed therein similar to those embodiments described herein.

From the above, it is to be appreciated that defined herein is an airflow curtain assembly including a fixed frame, a movable frame, and a plurality of curtain elements provided between the fixed frame and the movable frame and independently attached to the fixed frame and the movable frame. The movable frame is movable relative to the curtain elements and the fixed frame to position the curtain elements therebetween.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A conveyor system comprising:
a chute defining a recirculation zone enclosure; and
one or more airflow curtain assemblies, each airflow curtain assembly comprising:
a frame mounted to the recirculation zone enclosure; and
a curtain element extending from the frame, a plurality of slits formed in and extending from a lower end of the curtain element opposite the frame to define a plurality of curtain element strips.

2. The conveyor system of claim 1, wherein the one or more airflow curtain assemblies comprises three airflow curtain assemblies spaced apart from one another.

3. The conveyor system of claim 1, wherein each curtain element strip has a width equal to or greater than 45 mm and less than or equal to 55 mm.

4. The conveyor system of claim 1, wherein slit has a width equal to or greater than 10 mm and less than or equal to 15 mm.

5. The conveyor system of claim 1, wherein the lower end of the curtain element is curved.

6. An airflow curtain assembly comprising:
a fixed frame;
a movable frame; and
one or more curtain elements provided between the fixed frame and the movable frame and independently attached to the fixed frame and the movable frame.

7. The airflow curtain assembly of claim 6, wherein each curtain element includes a plurality of vertical adjustment slots arranged in a linear array in one or more columns.

8. The airflow curtain assembly of claim 7, further comprising a plurality of fasteners extendable through the fixed frame, the movable frame, and an associated one of the plurality of vertical adjustment slots of each of the one or more curtain elements.

9. The airflow curtain assembly of claim 6, wherein each curtain element has a plurality of slits formed in and extending from a lower end of the one or more curtain elements.

10. The airflow curtain assembly of claim 6, wherein each curtain element has a plurality of teeth formed on a first side edge and an opposite second side edge of an upper portion of the curtain element.

11. The airflow curtain assembly of claim 6, wherein, each curtain element has a plurality of teeth formed on a front surface of an upper portion of the curtain element.

12. The airflow curtain assembly of claim 6, wherein the one or more curtain elements, the fixed frame, and the movable frame each have a curved profile.

13. The airflow curtain assembly of claim 6, further comprises a pair of end seals provided between the fixed frame and the movable frame, the one or more curtain elements provided between the pair of end seals.

14. The airflow curtain assembly of claim 13, wherein the end seals are formed from rubber or polyurethane.

15. The airflow curtain assembly of claim 6, wherein each curtain element has a width equal to or greater than 50 mm and less than or equal to 500 mm.

16. The airflow curtain assembly of claim 6, wherein:
the fixed frame has a pair of holes formed at opposite ends of the fixed frame; and
the movable frame has a pair of slots formed at opposite ends of the movable frame, the slots having an elongated shape.

17. The airflow curtain assembly of claim 6, wherein the fixed frame includes a center recess formed on an inner surface of the fixed frame for receiving a center curtain element of the one or more curtain elements.

18. The airflow curtain assembly of claim 17, wherein a plurality of teeth are formed on opposite sides of the center recess.

19. The airflow curtain assembly of claim 17, wherein the movable frame includes a pair of side recesses formed on an inner surface of the movable frame at opposite ends of the movable frame for receiving respective side curtain elements of the one or more curtain elements.

20. The airflow curtain assembly of claim 6, wherein:
the fixed frame includes an upper wall extending from a lower wall at a first angle equal to or less than 70 degrees and greater than or equal to 45 degrees; and
the movable frame includes an upper wall extending from a lower wall at a second angle equal to or less than 135 degrees and greater than or equal to 110 degrees.
